(19) United States
(12) Patent Application Publication
(10) Pub. No.: US 2024/0169410 A1
(43) Pub. Date: May 23, 2024

(54) PREDICTIVE AGENTS FOR MULTI-ROUND CONVERSATIONAL RECOMMENDATIONS OF BUNDLED ITEMS

(71) Applicant: Adobe Inc., San Jose, CA (US)

(72) Inventors: Handong Zhao, San Jose, CA (US); Zhankui He, San Diego, CA (US); Tong Yu, San Jose, CA (US); Fan Du, Milpitas, CA (US); Sungchul Kim, San Jose, CA (US)

(21) Appl. No.: 17/980,790

(22) Filed: Nov. 4, 2022

(51) Int. Cl. G06Q 30/06

(52) U.S. Cl. CPC G06Q 30/0631

(57) ABSTRACT

Techniques for predicting and recommending item bundles in a multi-round conversation to discover a target item bundle that would be accepted by a client. An example method includes receiving an input response in reply to a first item bundle that includes one or more items. A state model is updated to reflect the input response to the first item bundle. A machine-learning (ML) conversation module is applied to the state model to determine an action type as a follow-up to the input response to the first item bundle. Based on selection of a recommendation action as the action type, an ML bundling module is applied to the state model to generate a second item bundle different than the first item bundle. The second item bundle is then recommended.

### TECHNICAL FIELD

This disclosure generally relates to machine learning for multi-round conversational recommendations and, more particularly, to techniques for using machine learning models to facilitate multi-round conversational recommendations of item bundles.

### BACKGROUND

Recommender systems are designed to recommend an item to be used or otherwise consumed by a target user, based on the target user's previous activities. For instance, an online shopping platform may include a recommender system that has access to a record of the user's historical interactions (e.g., purchase history) with the online shopping platform and uses that record to predict, and thereby recommend, other items the user might like to purchase. The recommender system can thus prompt additional purchases by the user and, as such, generate income for the online shopping system. Bundle recommender systems recommend sets of items meant to be used or consumed as a group. For instance, a bundle recommender system might recommend three items, such as a pair of pants, a short, and a pair of shoes, to be worn together as an outfit. Because bundle recommender systems recommend multiple items at once, bundle recommender systems have the potential to be even more valuable than recommender systems that recommend only a single item at a time.

Although valuable, bundle recommender systems suffer from at least two significant problems: interaction sparsity and large output space. Specifically, a bundle recommendation system potentially requires more information about a user, such as the user's interaction history, to determine not only what items the user might like but also which items the user might like as a united set. Additionally, the potential output space for recommending a single item has a size equal to the number of single items, while the potential output space for recommending a bundle is exponentially larger.

Existing approaches to bundle recommendations typically fall into two categories: discriminative method and generative methods. Discriminative methods predefine a set of bundles, and a set of items can only be recommended as bundle if that set of items is predefined as a bundle. Using this approach, an existing bundle recommendation system treats each predefined bundle as a unit item and makes recommendations based on which predefined bundle ranks highest for a given user. This approach has the significant drawback of lacking the ability to customize bundles to suit users. Generative methods are more flexible but still suffer from limited accuracy. In a generative approach, an existing bundle recommender system recommends a single bundle, which might be accepted or rejected by a user, but the bundle recommender system cannot then respond to refine a bundle that is rejected. This one-shot approach for generative methods thus does not allow refining a bundle that has been rejected.

### SUMMARY

Some embodiments of a recommendation system described herein recommend bundles, also referred to as item bundles, using a multi-round conversational recommendation (MCR) technique. In some embodiments described herein, a recommendation system employs multiple machine-learning (ML) modules, also referred to as agents. For instance, a first agent is a conversation module trained to direct conversations with users, such as by predicting whether a recommendation action or a question action should be output to users; a second agent is a bundling module trained to recommend item bundles for users, and a third agent is a question agent trained to generate questions to be posed to users to enable the recommendation system to predict items bundles that the users would find acceptable. As a result, the recommendation system can dynamically form item bundles and can refine such item bundles based on user input.

A recommendation system may be integrated with, or otherwise in communication with, an online platform associated with various items, such as products or services. For instance, the online platform may be configured to sell the various items. User may operate clients to access the online platform. Upon detecting a user's interactions with the online platform, an example of the recommendation system initiates a multi-round conversation with the user to try to predict a target item bundle, where the target item bundle is an item bundle (i.e., a bundle of items associated with the online platform) that the user accepts.

In some embodiments, a state model is a model of the user's current state from the perspective of the recommendation system. To begin the multi-round conversation, the conversation module of the recommendation system may predict an action type based on the state model. For instance, the action type is either a recommendation action or a question action. In some embodiments, if the action type is a recommendation action, then the bundling module predicts an item bundle, which the recommendation system then presents to the user. However, if the action type is a question action, then the question module predicts a question, which the recommendation system then poses to the user. In either case, the recommendation system may receive user input in response to the item bundle or question and may update the state model based on the user input. In some embodiments, additional rounds of conversation occur until a termination condition as met, such as by the user accepting an item bundle.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a diagram of an example of a recommendation system, according to some embodiments described herein.

FIG. 2 is a flow diagram of an example of a process for recommending item bundles to a user, according to some embodiments described herein.

FIG. 3 illustrates an example of a training system performing offline pre-training on machine-learning agents of the recommendation system, according to some embodiments described herein.

FIG. 4 illustrates an example of a training system performing online fine-tuning on machine-learning agents of the recommendation system, according to some embodiments described herein.

FIG. 5 is a diagram of an example of a computing system for performing certain operations described herein, according to some embodiments.

### DETAILED DESCRIPTION

Some embodiments of a recommendation system described herein recommend bundles, also referred to as item bundles, using a multi-round conversational recommendation (MCR) technique. Some embodiments could be in communication with, or integrated with, an online shopping platform to recommend bundles of items sold on that platform. However, embodiments are not limited to this context. For instance, embodiments could be associated with bundling services, such as insurance services or financial services. Various applications are possible and are within the scope of this disclosure. In some embodiments described herein, a recommendation system employs multiple machine-learning (ML) modules, or agents. For instance, three agents may be trained, respectively, to direct a multi-round conversation, to recommend item bundles, and to ask questions to facilitate further recommendations. As a result, the recommendation system can dynamically form item bundles and can refine such item bundles based on user input.

The following non-limiting example is provided to introduce certain embodiments. In this example, a recommendation system is integrated with an online shopping platform that sells various items. The recommendation system includes a modeling module, a conversation module, a bundling module, and a question module. Each of the conversation module, the bundling module, and the question module is an ML agent trained prior to operation of the recommendation system, and further, each ML agent has access to a state model describing information related to a user for which a target item bundle is sought to be predicted. The target item bundle is an item bundle that the user will accept, such as by purchasing the item bundle or adding the item bundle to a virtual shopping cart of the online shopping platform.

In some embodiments, the state model includes a long-term preference, a short-term context, an item pool, and an attribute pool. The long-term preference indicates item bundles that have previously been added to the user's cart, such as after having been recommended to the user. The short-term context, the item pool, and the attribute pool are related to a target item bundle sought to be identified. Specifically, the short-term context indicates items or attributes, if any, that have already been accepted by the user for the target item bundle. The target item bundle may have a given number of slots for the number of items that can make up the item bundle. For each such slot, the item pool indicates items that may still be included (e.g., have not yet been excluded) in the target item bundle at that slot, and the attribute pool indicates attributes (e.g., color, style) that may still be included at that slot.

In this example, after the recommendation system has made at least one recommendation of an item bundle, the modeling module receives an input response in reply to that item bundle. The modeling module then updates the state model to reflect the input response, such as by performing one or more of the following: removing an item from the item pool, removing an attribute from the attribute pool, or updating the short-term context to indicate any items or attributes that have been accepted according to the input response. The recommendation system may then use the conversation module to determine the next activity in the ongoing conversation between the recommendation system and the user. In particular, in this example, the conversation module inputs the state model and, based on the state model, predicts (i.e., selects) one of two action types: a recommendation action or a question action.

If the conversation module predicts a recommendation action, then this prediction triggers the bundling module in this example. The bundling module may then input the state model and, based on the state model, may predict (i.e., generate) a second item bundle. However, if the conversation module predicts a question action, then this prediction triggers the question module in this example. The question module may then input the state model and, based on the state model, may predict (i.e., generate) a question to pose to the user to help refine the item bundle to move toward the target item bundle. Regardless of whether the recommendation system outputs a second item bundle or a question, the user may provide another input response in reply. Then, again, the bundling module may predict a follow-up action.

In this example, the multi-round conversation continues until a termination condition is met. For instance, if the user accepts any item bundle predicted by the bundling module, such as by adding the item bundle to a virtual shopping cart or by purchasing the item bundle, then the multi-round conversation ends with the target item bundle having been predicted as the accepted item bundle. Alternatively, the multi-round conversation could end if a maximum number of rounds are reached, or if the user ignores a recommendation or question output by the recommendation system.

Certain embodiments described herein represent improvements in the technical fields of machine learning and multi-round conversational recommendation systems. Existing techniques for using machine learning to make recommendations do not effectively address the issue of item bundling, which has increased complexity compared to single-item recommendations due to interaction sparsity and large output space. Embodiments described herein address the interaction sparsity problem through the use of multiple machine-learning modules, each trained for a specific task (e.g., conversation, recommendation, or asking questions) so as to model a given user to provide better predictions. Further, embodiments described herein address the large output space by forming bundles on demand based on refinements made through multiple rounds of conversation using these ML modules.

As used herein, the term “item” refers to a product, service, or other entity that could be offered for sale, such as through an online platform. In some embodiments, and item is a physical product, but alternatively, an item could be a service or other entity.

As used herein, the term “item bundle” refers to a set of items offered as a collection. For instance, items in an item bundle could be capable of being used or otherwise consumed as a group. Some embodiments described herein generate and recommend item bundles. As used herein, the term “target item bundle” refers to a set of items that would be acceptable to a client or user to which the target item bundle is recommended.

As used herein, the term “attribute” refers to a descriptor of an item. For instance, an attribute could describe the style, color, or category of an item.

As used herein, the term “state model” refers to a dataset that represents a state of a client or a conversation between a client and a recommendation system, or both.

A used herein, the term “conversation module” refers to hardware, software, or a combination of hardware and software acting as a machine-learning agent that directs a conversation between a client and a recommendation system. For instance, the conversation module takes the state model as input and decides, on behalf of the recommendation system, whether to generate an item bundle or a question to be output to the client.

As used herein, the term “bundling module” refers to hardware, software, or a combination of hardware and software acting as a machine-learning agent that generates item bundles. For instance, the bundling module takes as input the state model and decides which items to collect into an item bundle for output to a client.

As used herein, the term “question module” refers to hardware, software, or a combination of hardware and software acting as a machine-learning agent that generates questions directed toward identifying a target item bundle. For instance, the question module takes as input the state model and generates questions related to attributes of potential items that could be included in the target item bundle.

As used herein, the term “modeling module” refers to hardware, software, or a combination of hardware and software that updates the state model based on received input responses in reply to item bundles generated by the bundling module and questions generated by the question module.

### Overview of a Recommendation System

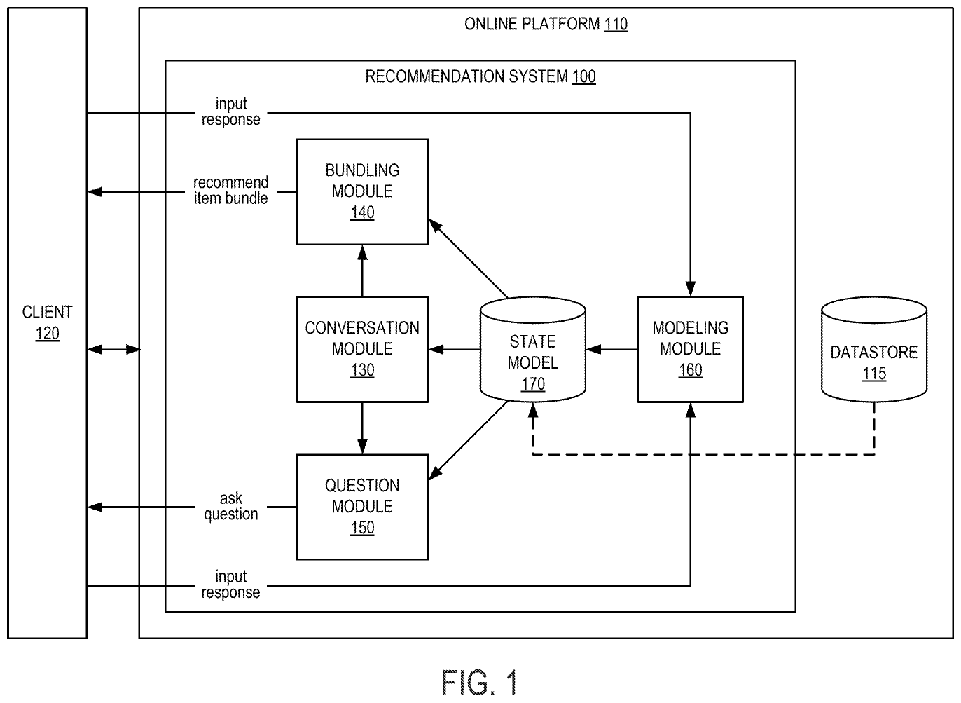

FIG. 1 is a diagram of an example of a recommendation system 100, according to some embodiments described herein. The recommendation system 100 may be integrated with, or otherwise in communication with, an online platform 110 to recommend bundles of items associated with (e.g., sold on) the online platform 110. For instance, the online platform 110 could be an online shopping platform configured to sell products or services. As such, the online platform 110 may be associated with a datastore 115, which includes information about items available through the online platform 110. Within the datastore 115, each item may be associated with a category (e.g., shoes, pants, toys) and with one or more attributes (e.g., colors, styles). The recommendation system 100 may recommend item bundles (i.e., sets of items in the datastore 115) to users operating clients 120 in communication with the online platform 110.

In some embodiments, one or more clients 120 are configured to access the online platform 110, and the recommendation system 100 can recommend item bundles for various clients 120 in parallel. Thus, although FIG. 1 shows a single client 120 and although this disclosure occasionally refers to a client 120, in the singular, it will be understood that the recommendation system 100 may communicate with, and make recommendations to, various clients 120 in parallel.

As shown in FIG. 1, an example of the recommendation system 100 includes a conversation module 130, a bundling module 140, a question module 150, a modeling module 160, and a state model 170. Each of the conversation module 130, the bundling module 140, and the question module 150 may be a respective ML model trained to take a respective role in a multi-round conversation with a user, where that multi-round conversation is directed toward eventually predicting a target item bundle for the user. Additionally, in some embodiments, each of the conversation module 130, the bundling module 140, and the question module 150 takes as input at least a portion of a state model 170, which represents the user, to make a prediction for the multi-round conversation. The target item bundle is a bundle of items accepted by the user. Generally, the conversation module 130 directs a multi-round conversation with a user by determining whether a given round of the conversation will involve a recommendation or a question. If the conversation module 130 predicts (i.e., determines) that the given round should involve recommending an item bundle, the bundling module 140 then predicts (i.e., generates) an item bundle to be recommended. If the conversation module 130 predicts (i.e., determines) that the given round should involve posing a question to the user, then the question module 150 predicts (i.e., generates) a question to be posed to the user. In either case, the user can then provide user input, which the modeling module 160 may incorporate into the state model 170 to provide a more refined representation of the user for the next round of the conversation. In some embodiments, the conversation continues until a termination condition is met.

In some embodiments, a state model 170 is a model of a user or, more practically, of a client 120 operated by a user. The recommendation inputs aspects of the state model into the conversation module 130, the bundling module 140, and the question module 150 as needed to enable these ML agents to make predictions based on this model of the user. In some examples, a state model 170 includes a long-term preference, a short-term context, and one or more candidate pools. A state model 170 may additionally be associated with a results feature, which is an ordered list of results of prior conversation rounds.

For instance, the long-term preference represents the user's shown preferences over time, such as be indicating an ordered set of item bundles accepted by the user in the past. Within the ordered set, each item bundle may include a set of items. In some embodiments, the item bundles recommended, and thus those represented in the long-term preference, have a fixed number of slots for a fixed number of items (e.g., three items per item bundle). In the case of a newly initialized state model 170, the long-term preference may be an empty set.

In some embodiments, the short-term context represents a shorter time than does the long-term preferences. For instance, the short-term context indicates the user's preferences during an ongoing or current multi-round conversation to find a target item bundle. In one example, the target item bundle is assumed to have a fixed number of slots (e.g., three slots), and the short-term context is a set of tuples having a quantity of tuples equal to the quantity of slots, with each tuple being associated with a single slot of the target item bundle. Each tuple of the short-term context can indicate an accepted item (if any), an accepted category (if any), and an accepted attribute (if any) for the corresponding slot of the target item bundle. An accepted item may be a specific item, such as a singular item having a unique identifier; an accepted category may define a type of items, such as a pants category, a jackets category, a or a shoes category; and an accepted attribute may be description of items, such as a specific color or style. In some embodiments, in the case where an item, category, or attribute has not yet been accepted for a given slot, the short-term context may include a predefined mask in the corresponding position of the tuple.

The one or more candidate pools may include one or more of the following: an item pool, a category pool, or an attribute pool. The item pool, also referred to herein as the item candidate pool, may indicate, for each slot of the target item bundle, which items in the datastore 115 are still candidates to be included at that slot. The category pool, also referred to herein as the category candidate pool, may indicate, for each slot in the target item bundle, categories that have not been excluded as possible categories of items that might be placed at that slot. The attribute pool, also referred to herein as the attribute candidate pool, may indicate, for each slot in the target item bundle, attributes that have not been excluded as possible descriptors of items that might be placed at that slot. In one example, if a user rejects a first item presented in a recommended item bundle, the recommendation system 100 may then remove that first item from all slots of the item candidate pool. In another example, if the user indicates a preference for blue skirts, the recommendation system may select a given slot of the target bundle, exclude from the category pool all categories other than skirts at the given slot, and exclude from the attribute pool all colors other than blue at the given slot. In contrast, if the user indicates that a skirt is not desired, the recommendation system may exclude items that are skirts from all slots of the item pool and may exclude the category of skirts from all slots of the category pool.

The candidate pools may be stored as black lists, white lists, or a combination of both, depending on implemented preferences. In some embodiments, the candidate pools may be initialized such that all items in the datastore 115 are candidates for each slot of the target item bundle or, in another example, such that each slot is associated with a given category attribute (e.g., pants, shirts, shoes) and items outside of a category attribute are thus excluded from the candidate pools of the corresponding slot. Various implementations are possible and are within the scope of this disclosure.

Various computing devices may be used to implement the recommendation system 100 or a client 120 in communication with the recommendation system 100. For instance, the recommendation system 100 may be implemented as a computer server remote from the client 120, or the recommendation system 100 may be implemented as a set of one or more computing nodes operating in a cloud system. Various components of the recommendation system 100, such as the conversation module 130, the bundling module 140, the question module 150, the state model 170, or the modeling module, may be remote from one another or under control of different parties. A client 120 may be implemented as a computing device or portion of a computing device. For instance, a client 120 could be an application running on a computing device, where that application is used to access the online platform 110 and to communicate with the recommendation system 100, or a client 120 could be a complete computing device, such as an embedded device. Various implementations are possible and within the scope of this disclosure.

### Example Operations of a Recommendation System

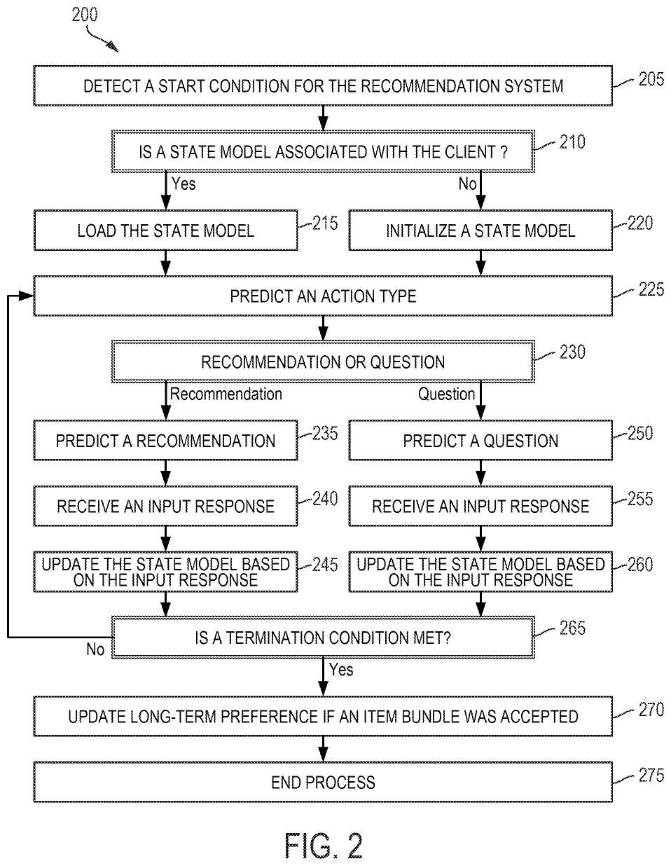

FIG. 2 is a flow diagram of an example of a process 200 for recommending item bundles to a user, according to some embodiments described herein. Prior to execution of this process, the various ML agents of the recommendation system 100, such as the conversation module 130, the bundling module 140, and the question module 150, may be trained to perform their respective tasks, as described in detail below. Various aspects of the recommendation system 100 may perform the process 200 of FIG. 2 or similar for a user operating a client 120 connected to the online platform 110. Further, the recommendation system 100 may perform this process 200 or similar each time the client 120 connects to the online platform 110 and, in some cases, multiple times per connection of the client 120 to the online platform 110.

The process 200 depicted in FIG. 2 may be implemented in software executed by one or more processing units of a computing system, implemented in hardware, or implemented as a combination of software and hardware. This process 200 is intended to be illustrative and non-limiting. Although FIG. 2 depicts various processing operations occurring in a particular order, the particular order depicted is not required. In certain alternative embodiments, the processing may be performed in a different order, some operations may be performed in parallel, or operations may be added, removed, or combined together.

As shown in FIG. 2, at block 205, the process 200 involves detecting a start condition, at which the recommendation system 100 begins a multi-round conversation to predict a target item bundle for a user. The start condition can take various forms. In one example, the recommendation system 100, being integrated with or in communication with the online platform 110, may detect that the start condition is met when a client 120 has been connected to the online platform for a minimum amount of time (e.g., five minutes). In another example the recommendation system 100 may detect that the start condition is met when a client browses an item in the datastore 115 of the online platform 110. Upon detecting that the start condition has been met, the recommendation system 100 may then initiate a multi-round conversation to predict a target item bundle for the user associated with the client 120, as described herein.

At decision block 210, the process 200 involves determining whether a state model 170 is already associated with the client 120. Although the state model 170 may be a model of a user, in some embodiments, the state model 170 effectively represents a client 120 associated with a user. Further, a client 120 can be identified in various ways, such as by a user account associated with the client 120, an identifier of the client 120 (e.g., an Internet Protocol address or a Media Access Control address), or a combination of both. For instance, if the client 120 is logged into a user account on the online platform 110, then the recommendation system 100 may associate a state model 170 with the user account and may use that state model 170 each time the client 120, or another client 120, is logged into that user account. However, if the client 120 is not logged into any user account, the recommendation system 100 may associate a state model with the client 120 itself (e.g., with an Internet Protocol address or other identifier of the client 120) or with an account to which the client 120 was previously logged in. Various implementations are possible and are within the scope of this disclosure. If the recommendation system 100 identifies an existing state model 170 associated with the client 120 (e.g., associated with the client 120 itself or with a user account associated with the client 120), then the process 200 proceeds to block 215; otherwise, the process 200 skips to block 220.

If the recommendation system 100 identifies a state model 170 that is already associated with the client 120, then at block 215, the process 200 involves loading the state model 170 that is already associated with the client 120. As such, the state model 170 referred to in the below operations of this process 200 is the state model 170 identified above in block 210. If no existing state model 170 is identified for the client, however, then at block 220, the process 200 involves initializing a new state model 170 associated with the client 120. In either case, the process 200 may then continue to block 225.

As described above, in some embodiments, the recommendation system 100 facilitates a multi-round conversation with the user to predict a target item bundle. This multi-round conversation begins at block 225, at which the process 200 involves predicting an action type. For instance, the action type may be selected from the set including a recommendation action and a question action. To predict the action, the conversation module 130 may take as input the state model 170 and the results feature and may generate an output. The output may be a binary output indicating an action type, which is either a recommendation action or a question action, for instance. At decision block 230, if a recommendation action is predicted, then the recommendation system 100 triggers the bundling module 140 and the process proceeds to block 235; however, if a question action is predicted, then the recommendation system 100 triggers the question module 150 and the process 200 skips ahead to block 245.

At block 235, the process 200 involves predicting an item bundle to recommend to the user at the client 120. Specifically, in some embodiments, the bundling module 140 takes the state model 170 as input and, based on the state model 170, generates an item bundle. Specifically, for instance, for each slot of the target item bundle, the bundling module 140 outputs a unique item selected from the item pool corresponding to that slot. The modeling module 160 of the recommendation system 100 may transmit the item bundle to the client 120 as a recommendation.

In some embodiments, at block 240, the modeling module of the recommendation system 100 receives an input response from the client 120 in reply to the recommendation, and at block 245, the modeling module 160 updates the state model 170 to reflect the input response. In some embodiments, the input response is a full acceptance of the item bundle, a rejection in whole or part, or a timeout indicating that the user has ignored the item bundle. For instance, the input response indicates that one or more items are accepted or rejected, and the modeling module 160 updates one or more candidate pools or the short-term context, or a combination of both, to reflect this. In one example, the input response could be an acceptance of the item bundle, which could be indicated by the client 120 adding the item bundle to a virtual shopping cart or by purchase of the item bundle. In that case, updating the state model 170 could involve updating the short-term context to indicate each specific item in the item bundle, or updating the state model 170 could involve updating the long-term preference to add the item bundle to the long-term preference. In another example, the input response could be a partial acceptance and partial rejection, which could be indicated by the user adding one or more, but not all, items of the item bundle to a virtual shopping cart or by the user otherwise indicating that one or more items are accepted while one or more items are rejected. In that case, updating the state model 170 could include one or more of (a) removing from the item pool any items of the item bundle that were rejected or (b) adding to the short-term context any items that were accepted in the input response.

However, if the prediction action type at decision block 230 is a question action, then at block 250, the process 200 involves predicting a question to post to the user at the client 120. Specifically, in some embodiments, the question module 150 takes the state model 170 as input and, based on the state model 170, generates output indicating a question. Specifically, for example, the question module 150 may output, for each slot in the target item bundle, a category selected from the category pool and an attribute selected from the attribute pool. This output can indication a question. For instance, for a target item bundle with two slots, the question module 150 could output the category “pants” and the attribute “sport-style” for a first slot and the category “shoes” and the attribute “white” for the second slot. In that case, the generated question could be, “Would you like sport-style pants with white shoes?” The modeling module 160 of the recommendation system 100 may transmit the question to the client 120.

In some embodiments, at block 255, the modeling module of the recommendation system 100 receives an input response from the client 120 in reply to the question, and at block 260, the modeling module 160 updates the state model 170 based on the input response. For instance, the input response refines the categories, attributes, or items, or a combination of these, for at least one slot of the target item bundle, and the modeling module 160 thus updates one or more of the candidate pools to reflect this refinement. In one example, the input response indicates a category and attribute, such as a color, for a given slot of the target item bundle. In that case, updating the state model 170 could include one or more of (a) updating the short-term context to indicate an accepted category or attribute for the given slot of the target item bundle, (b) updating the category pool to remove categories other than the accepted category at the given slot, or (c) updating the attribute pool to remove attributes other than the accepted attribute at the given slot.

In some embodiments, at decision block 265, the process 200 involves determining whether a termination condition is met. In some embodiments, terminations conditions include one or more of the following: the input response is blank (e.g., the user at the client ignored the item bundle or question); the input response is blank and the input response in the immediately previous round of the multi-round conversation was also blank; the input response indicates an acceptance of the item bundle; or a maximum number of rounds in the multi-round conversation have occurred. If no termination condition is met, the process 200 can return to block 225 to begin another round of the multi-round conversation. However, if a termination condition is met, then at block 270 the process 200 involves updating the long-term preference to add the accepted item bundle, if indeed an item bundle was accepted. At block 275, the process 200 can end.

### Example Architecture of the Recommendation System

In some embodiments, the recommendation system 100 performs two general stages of operations: a consultation stage and a modeling stage. For the consultation stage, the recommendation system 100 is implemented as a two-step Markov Decision Process (MDP) problem with multiple ML agents. As described above, the two-step decision technique may involve determining whether to recommend or ask and then determining what to recommend or ask. Specifically, the conversation module 130 determines an action type, such as a recommendation action or a question action. If the action type is a recommendation action, the bundling module 140 generates a recommendation, but if the action type is a question action, the question module 150 generates a question. In the modeling stage, the modeling module 160 of the recommendation system 100 updates the state model 170 based on an input response to the recommendation or question.

As described above, an example of the state model 170 represents the current conversation in the form of a short-term context and one or more candidate pools and can further model a long-term preference associated with the client 120. In this disclosure, Sᵤ^{(t)} refers to a state model 170 at conversation round t, and the state model 170 for a particular user of a set of users (u∈U) can be defined as follows:

Sᵤ^{(t)}=({B₁, . . . , B_{N}_{ᵤ}}, {(l̅ₛ^{(t)},Āₛ^{(t)})ₛ₌₁^{N}^{ₜ}}, {Iₛ^{(t)},Aₛ^{(t)}})

In the above, {B₁, . . . , B_{N}_{ᵤ}} is the long-term preference, which can be an ordered set of historical bundle interactions, such as item bundles accepted by the user. Nᵤ is the number of item bundles accepted historically, and N^{t} is the number of slots in the target item bundle. In some embodiments, N^{t} is predefined and fixed. The feature {(l̅ₛ^{(t)},Āₛ^{(t)})ₛ₌₁^{N}^{ₜ}} is the short-term context, which can be a set of Nₜ tuples of conversational contexts collected in conversation rounds prior to conversation round t. For each element in the tuple at round t, iₛ^{(t)} denotes an item identifier for an item accepted for slot s of the target bundle; and Āₛ^{(t)} is the is the set of accepted attributes for slot s of the target bundle. The feature {I^{(t)},A^{(t)}} is the set of candidate pools. Specifically, Iₛ^{(t)} is the item pool for slot s of the target bundle; and Aₛ^{(t)} is the attribute pool for slot s of the target bundle.

Some embodiments use {(l̅ₛ^{(t)},C̅ₛ^{(t)}Āₛ^{(t)})ₛ₌₁^{N}^{ₜ}} as the short-term context in contrast to the above, and in that case C̅ₛ^{(t)} can be the is the set of accepted categories for slot s of the target bundle. Such embodiments can also include a category pool Cₛ^{(t)} as an additional candidate pool. However, the category of an item could be described as an attribute, in which case defining categories as separate from attributes can be avoided to reduce complexity. Thus, throughout this disclosure, it will be understood that categories can be treated separately from attributes or as a subset of attributes.

In some embodiments, the state model 170 is associated with a results feature Rᵤ^{(t)}, which is an ordered list of results of conversation rounds prior to the conversation round t in the current multi-round conversation. For instance, each element of Rᵤ^{(t)} indicates whether the corresponding conversation round involved a recommendation or an ask, as well as an indication or whether an item bundle has been accepted at the conclusion of that conversation round. For instance, an example of the feature Rᵤ^{(t)} could be equal to the ordered set {rec_fail, ask_fail, ask_fail, rec_fail, . . . }.

In existing MCR frameworks, individual attributes or items are recorded in a state, but there is no correspondence between attributes and items, such as described above by the use of slots. In existing MCR frameworks, the goal is to get an acceptance for a single item, which requires a lower degree of complexity and no such correspondence. Further, in contrast to existing MCR frameworks, some embodiments of a recommendation system 100 herein utilize a self-attentive encoder to encode the long-term preference, as described in more detail below.

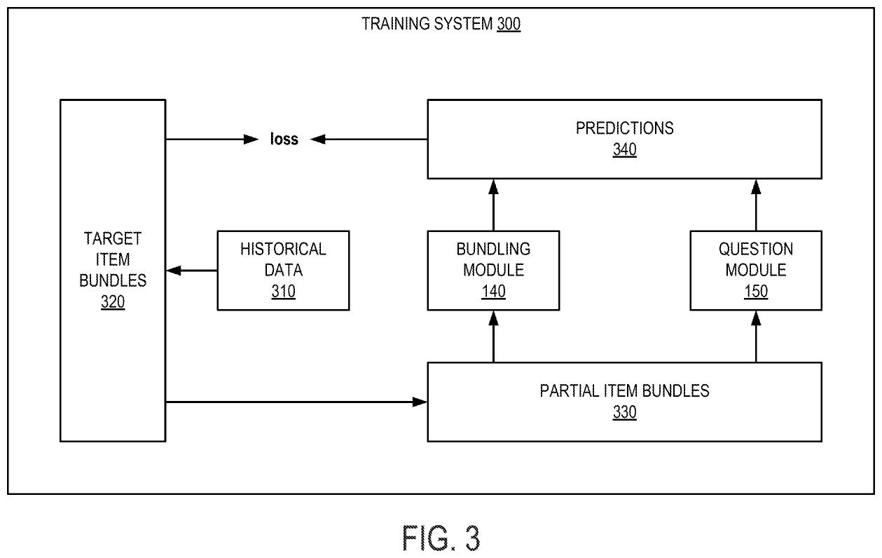

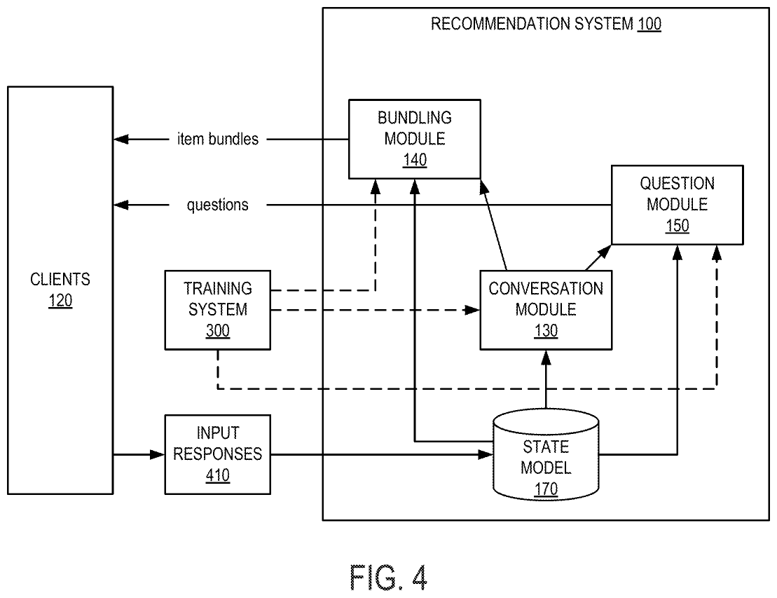

As described above, some embodiments of the recommendation system include three machine-learning agents used in the consultation stage: a conversation module 130, a bundling module 140, and a question module 150. Each of these ML agents may take the state model 170 as input. In some embodiments, as described further below, a training system 300 (FIGS. 3-4) trains the ML agents to learn respective policy networks. Specifically, the conversation module 130 learns a policy network π_{C} to direct the conversation by determining whether to make a conversation or ask a question; the bundling module 140 learns a policy network π_{B} to generate item bundles deemed likely to be accepted; and the question module 150 learns a policy network π_{Q} to generate questions deemed likely to elicit a useful response to refine potential item bundles that might be recommended.

Upon receipt of an input response from the client 120 in reply to a recommendation or question, the modeling stage occurs. In some embodiments, the modeling module 160 of the recommendation system 100 updates the state model 170 and, if applicable, the results feature to reflect the most recent consultation stage. In some embodiments, the long-term preference of the state model 170 is fixed throughout the multi-round conversation, unless and until an item bundle is accepted. However, as described above, the modeling module 160 may update the short-term context, the item pool, the category pool, the attribute pool, or a combination of these.

In some embodiments, the training system 300 trains the ML agents using two levels of rewards. The bundling module 140 and the question module 150 receive low-level rewards, including a respective low-level reward for each slot, to encourage useful recommendations and questions. For instance, at conversation round t, for each slot x, the reward to the bundling module 140 is r^{B}ₓ=1 if the client 120 indicates acceptance of the item recommended in that slot; otherwise, the reward is r^{B}ₓ=0. Further, for instance, at conversation round t, for each slot x, the reward to the question module 150 is r^{Q}ₓ=1 if the client 120 indicates a positive answer (e.g., “yes” as opposed to “no”) to a question related to that slot; otherwise, the reward is r^{Q}ₓ=0. The conversation module 130 may receive high-level rewards reflecting the quality of the multi-round conversation as a whole. For instance, the reward to the conversation module 130 is r^{C}ₓ=0 unless a termination condition is met. If a termination condition is met, then the reward r^{C}ₓ may be computed using a bundle metric, such as an existing bundle metric (e.g., F1 score or accuracy).

Using the above framework, some embodiments of the ML agents of the recommendation system 100 are trained jointly using a combination of offline training and online training. In some embodiments, the architecture of the combined conversation module 130, bundling module 140, and question module 150 is an encoder-decoder framework with multi-type inputs and multi-type outputs to handle user modeling, consultation, and input handling. A basic encoder-decoder framework is commonly used in traditional bundle recommendation tasks. However, the recommendation system 100 can use a self-attentive version of that basic architecture. Self-attentive models are effective at representation encoding and accurate at decoding in recommendation tasks. Input for a recursive neural network (RNN), in contrast, have to be ordered, while a self-attentive model discards unnecessary order information to reflect the unordered property of bundles. Additionally, a self-attentive model can be effectively used in doze tasks, making such a model suitable for predicting unknown items, categories, or attributes in slots.

In some embodiments, the recommendation system 100 encodes user historical interaction (i.e., item bundles accepted in the past), {B₁, . . . , B_{N}_{ᵤ}}, using hierarchical transformer encoders. For instance, the long-term preference is encoded as follows: Eᵤ=TRM_{bundle}({b₁, . . . , b_{N}_{ᵤ}}), where bₙ=AVG(TRMᵢₜₑₘ(Bₙ)), n=1, 2, . . . . In this formula, TRM_{bundle} is a transformer encoder over the set of bundle-level representations {b₁, . . . , b_{N}_{ᵤ}}; the output Eᵤ∈ [symbol] _{N}_{ᵤ}^{×d} represents user long-term preferences, Nᵤ is the number of item bundles accepted historically, and d is the hidden size of the TRM_{bundle} model. The bundle representation Bₙ∈ [symbol] ^{1×d} can be extracted by a transformer encoder, such as TRMᵢₜₑₘ, over the set of item embeddings in this bundle. The set of output embeddings from TRMᵢₜₑₘ can be aggregated by average pooling AVG as Bₙ. In some embodiments, these two-level transformers include no positional embeddings because the input representations are unordered.

In some embodiments, the short-term context is {(l̅ₓ^{(t)},Āₓ^{(t)})|x∈X^{(≤t)}}, where X^{(≤t)} is the set of slots, and x is a given slot. In some embodiments, the recommendation system 100 feeds the short-term context into an embeddings layer EMB to obtain two sets of embeddings for items and attributes respectively:

E_{I,u}^{(t)},E_{A,u}^{(t)}=EMB({l̅ₓ^{(t)},Āₓ^{(t)}|x∈X^{(≤t)}})

In the above, E_{I,u}^{(t)}∈ [symbol] ^{|X}^{^{(≤t)}}^{|×d} denotes item embeddings, and E_{A,u}^{(t)}∈ [symbol] ^{|X}^{^{(≤t)}}^{|×d} denotes attribute embeddings. For items, the recommendation system 100 can retrieve embeddings of identifiers of accepted items or, in the case an item not having been accepted for a given slot, a mask identifier. For attributes, the recommendation system 100 can retrieve embeddings corresponding to identifiers of accepted attributes or, in the case of an attribute not having been accepted for a given slot, a padding. The recommendation system 100 can then apply pooling AVG on the embeddings to obtain E_{A,u}^{(t)}∈ [symbol] ^{|X}^{^{(≤t)}}^{|×d}.

In some embodiments, the recommendation system 100 feeds the long-term preference Eᵤ and the short-term context E_{*,u}^{(l)} into an L-layer transformer. For notation simplicity, in this disclosure, E_{I,u}^{(t)} is denoted as O⁰. The fused representation can be as follows: O^{l}=TRM^{l}(Õ^{l-1},Eᵤ),Õ^{l-1}=LN(O^{l-1}⊕E_{A,u}^{(t)}W^{l-1}), where l=1, . . . , L. In this formula, TRMₗ is the lth transformer layer with cross attention; W^{l-1}∈ [symbol] ^{d×d} is a learnable projection matrix at layer l−1 for attribute representation; ⊕ is the element-wise addition operator; and LN denotes LayerNorm for training stabilization. Some embodiments incorporate the attribute feature E_{A,u}^{(t)}, as shown above, before each transformer layer to incorporate multi-resolution levels, which can be effective in transformer-based recommender models. Thus, for the output representation O^{L}∈ [symbol] ^{|X}^{^{(≤)}}^{|×d}, each row Oₓ^{L}(x∈X^{(≤t)}) includes contextual information from the slots in conversation contexts. The output representation O^{L} and the candidate pols for all slots x∈X^{(≤t)} can be treated as the encoded state model 170, Sᵤ^{(t)}. Additionally, in some embodiments, the results feature S̅ᵤ^{(t)} can be encoded as a vector using result embeddings and average pooling.

As discussed above, operation of the recommendation system 100 can include conversation rounds, each with a consultation stage and a modeling stage. In some embodiments, for the consultation stage, the recommendation system 100 feeds the encoded state model 170, such as described above, into the multiple policy networks to get outputs for each slot x∈X^{(t)}, as follows for the conversation module 130, the bundling module 140, and the question module respectively:

$$\{ \begin{matrix}{P}_{C} ( a \vert {\overline{S}}_{u}^{( t )} , {O}_{x}^{L} ) = β \cdot {π}_{C}^{′} ( a \vert {\overline{S}}_{u}^{( t )} ) + ( 1 - β ) \cdot {π}_{C}^{″} ( a \vert {O}_{x}^{L} ) , where a ∈ \{ 0 , 1 \} \\ {P}_{B} ( a \vert {O}_{x}^{L} ) = {π}_{B} ( a \vert {O}_{x}^{L} ) , where a ∈ {I}_{s}^{( t )} \\ {P}_{Q} ( a \vert {O}_{x}^{L} ) = {π}_{Q} ( a \vert {O}_{x}^{L} ) , where a ∈ {A}_{s}^{( t )}\end{matrix}$$

In the above, P_{*} is a probability; for the conversation module 130, policy network π_{C} is linearly combined by the two sub-models π′_{C} and π″_{C} for state S̅ᵤ^{(t)} and Oₓ^{L} respectively; and β is a gating weight. In some embodiments, π′_{C}, π″_{C}, π_{B}, and π_{Q} are multilayer perceptron (MLP) models with rectified linear unit (ReLU) activation and a softmax layer. Some embodiments use π_{B} or π_{Q} to infer masked items or attributes in slot x. During inference, some embodiments the action with the highest probability to decide whether to perform a recommendation action or a question action. In contrast to existing recommender systems for single items, in some embodiments, the contextual information stored in the various slots can impact recommendations; thus, the encoded state can be shared across the slots for both item bundle and question predictions in a unified self-attentive architecture, as described herein.

### Example of Training the Recommendation System

FIG. 3 and FIG. 4 are diagrams of an example of a training system 300 for training the ML agents, specifically the conversation module 130, the bundling module 140, and the question module 150, of the recommendation system. Specifically, FIG. 3 illustrates the training system 300 performing an offline pre-training aspect of training, and FIG. 4 illustrates the training system 300 performing an online fine-tuning aspect of training. The training system 300 can be implemented as hardware, software, or a combination of both. For instance, the training system 300 can be implemented as software running across one or more hardware devices. In some embodiments, the training system 300 is integrated with other aspects of the recommendation system 100, such that hardware or software, or both, are shared across the training system 300 and other aspects of the recommendation system 100. Alternatively, however, the training system 300 may operate separately from other aspects of the recommendation system 100. For instance, after the training system 300 trains the conversation module 130, the bundling module 140, and the question module 150, the resulting trained ML models can then be copied to, or otherwise integrated with, the recommendation system 100 for operation.

Due to the large action spaces of items and attributes, it could be difficult to directly train the ML agents of the recommendation system 100 from scratch. Thus, some embodiments of the training system 300 perform training in two stages, including offline pre-training as shown in FIG. 3 and online fine-tuning as shown in FIG. 4. During offline pre-training, the training system 300 can train the ML agents on collected offline user-bundle interactions. In some embodiments, offline pre-training as performed by the training system 300 mimics inputs and outputs that occur during operation of the recommendation system 100. Thus, offline pre-training can be treated as multiple doze (i.e., “fill the slot”) tasks given a few accepted items and attributes to infer unknown (i.e., masked) items and attributes.

In some embodiments, offline pre-training is based on a multitask loss for item-bundling and question-asking simultaneously. In other words, L_{offline}=L_{bundling}+λL_{question}, where λ is a trade-off hyper parameter to balance the importance of the item-bundling loss L_{bundling} and the question-asking loss L_{question}. Some embodiments thus treat the combination of predictions as a multi-class classification task for masked slots X^{(t)}, as follows:

$${L}_{bundling} = - {\sum }_{x ∈ {X}^{( t )}} {\sum }_{i ∈ {I}_{x}^{( t )}} {y}_{i} log {P}_{B} ( i \vert {O}_{x}^{L} )$$

In the above, yᵢ is a binary label (i.e., 0 or 1) for item i.

In some embodiments, attribute predictions are formulated as multi-label classification tasks. For instance, the training system 300 uses a weighted cross-entropy loss function considering the imbalance of labels to prevent the question module 150 from predicting only popular attributes. The loss function of attribute predictions can be as follows:

$${L}_{question} = - {\sum }_{x ∈ {X}^{( t )}} {\sum }_{a ∈ {A}_{x}^{( t )}} {w}_{a} \cdot {y}_{a} log {P}_{Q} ( a \vert {O}_{x}^{L} )$$

In the above, wₐ is a balance weight of attribute a. Further, in some instances, multiple yₐ can have values of 1 for multi-label classification.

In some embodiments, the training system 300 performs offline pre-training on the conversation module 130, as π″_{C}, to decide whether to generate an item bundle or a question as follows:

$${L}_{conversation} = - {\sum }_{x ∈ {X}^{( t )}} ℤ ( {l}_{x} \neq - 1 ) \cdot log {π}_{C}^{″} ( {l}_{x} \vert {O}_{x}^{L} )$$

For a given slot x, if the bundling module 140 hits the target item, lₓ can be set to 1; otherwise, lₓ can be set to 0. Additionally, lₓ can be set to −1 when no ML agents make successful predictions.

As shown in FIG. 3, during training, an example of the training system 300 trains the bundling module 140 and the question module 150 with partial item bundles 320 extracted from target item bundles 320 in historical data 310. The partial item bundles 320 can include items and attributes. In turn, the conversation module 140 and the question module 150 make predictions 340, from which the training system 300 generates a loss through comparison with data describing the target item bundles 320, using loss functions such as those described above.

In some embodiments, the training system 300 performs online fine-tuning to mimic actual operation of the conversation module 130, the bundling module 140, and the question module 150 in the recommendation system 100. For instance, the online fine-tuning can occur during operation of the recommendation system 100 (i.e., while legitimate clients 120 interact with and use the recommendation system 100) or can utilize simulated data that mimics real operation. In some embodiments, during online fine-tuning, the training system 300 continues to update the conversation module 130, the bundling module 140, and the question module 150 based on successes (e.g., acceptances of items or item bundles, “yes” answers to questions) and failures that occur.

In FIG. 4, the online fine-tuning occurs during real operation of the recommendation system 100. As shown, in some embodiments, the conversation module 130 makes decisions about whether to generate an item bundle or a question as appropriate and, as such, triggers either the bundling module 140 or the question module 150. The recommendation system 100 outputs item bundles and questions to clients 120 as described herein. The recommendation system 100 receives input responses 410 from clients 120 in reply and accordingly updates the state models 170 associated with the clients 120. The training system 300 uses the input responses 410 to reward the conversation module 130, the recommendation module 140, and the question module 150 based on successes and failures as reflected by the input responses 410.

### Example of a Computing System for Implementing the Recommendation System

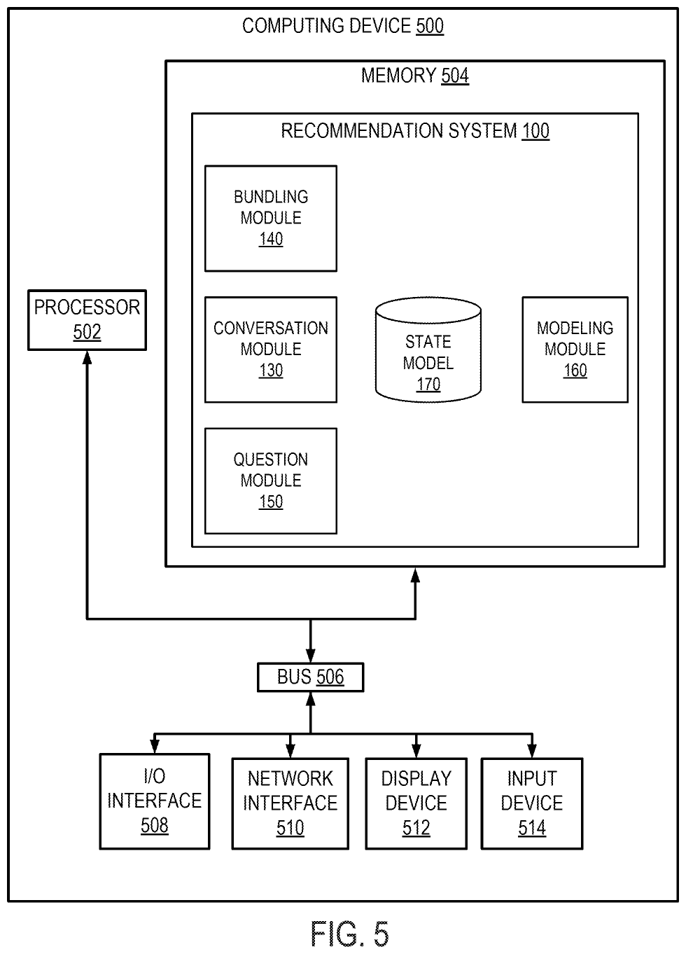

FIG. 5 is a diagram of an example of a computing system 500 for performing certain operations described herein, according to some embodiments. A suitable computing system or group of computing systems can be used for performing the operations described herein. For example, FIG. 5 depicts an example of a computing system 500 that can be used to execute the recommendation system 100, including the modeling module 160, the conversation module 130, the bundling module 140, the question module 150, or various other aspects described herein. In some embodiments, as shown for instance, the computing system 500 executes the recommendation system 100, and an additional computing system having devices similar to those depicted in FIG. 5 (e.g., a processor, a memory, etc.) trains each of the machine-learning agents (e.g., the conversation module 130, the bundling module 140, and the question module 150) of the recommendation system 100. In that case, each of these ML agents may be copied into the recommendation system 100 after training is complete. In other embodiments, however, the computing system 500 both trains the ML agents and executes the recommendation system 100 using the ML agents.

The depicted example of a computing system 500 includes a processor 502 communicatively coupled to one or more memory devices 504. The processor 502 executes computer-executable program code stored in a memory device 504, accesses information stored in the memory device 504, or both. Examples of the processor 502 include a microprocessor, an application-specific integrated circuit (“ASIC”), a field-programmable gate array (“FPGA”), or any other suitable processing device. The processor 502 can include any number of processing devices, including a single processing device.

The memory device 504 includes any suitable non-transitory computer-readable medium for storing data, program code, or both. A computer-readable medium can include any electronic, optical, magnetic, or other storage device capable of providing a processor with data or with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 500 executes program code that configures the processor 502 to perform one or more of the operations described herein. The program code includes, for example, instructions for the modeling module, the conversation module, the bundling module, the question module, or other aspects of the recommendation system 100. The program code may be resident in the memory device 504 or any suitable computer-readable medium and may be executed by the processor 502 or any other suitable processor.

The computing system 500 can access other models, datasets, or functions of the recommendation system 100 in any suitable manner. In some embodiments, some or all of one or more of these models, datasets, and functions are stored in the memory device 504 of a computer system 500, as in the example depicted in FIG. 5. In other embodiments, a separate computing system can provide access to necessary models, datasets, and functions as needed. For instance, as shown in FIG. 5, the state model 170 of the recommendation system 100 may be at least a portion of the memory device 504 of the computing system 500. Additionally or alternatively, aspects of the state model 170 may be stored remotely and accessible via a data network.

The computing system 500 also includes a network interface device 510. The network interface device 510 includes any device or group of devices suitable for establishing a wired or wireless data connection to one or more data networks. Non-limiting examples of the network interface device 510 include an Ethernet network adapter, a modem, and the like. The computing system 500 is able to communicate with one or more other computing devices (e.g., a separate computing device acting as a client 120) via a data network using the network interface device 510.

The computing system 500 may also include a number of external or internal devices, such as input or output devices. For example, the computing system 500 is shown with one or more input/output (“I/O”) interfaces 508. An I/O interface 508 can receive input from input devices or provide output to output devices. One or more buses 506 are also included in the computing system 500. The bus 506 communicatively couples together one or more components of the computing system 500.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method comprising:
receiving an input response in reply to a first item bundle comprising one or more items;
updating a state model to reflect the input response to the first item bundle;
applying a machine-learning (ML) conversation module to the state model to determine an action type as a follow-up to the input response to the first item bundle;
based on selection of a recommendation action as the action type, applying an ML bundling module to the state model to generate a second item bundle different than the first item bundle; and
recommending the second item bundle.

2. The method of claim 1, wherein the one or more items of the first item bundle comprise a first item, selected from an item candidate pool and having a first attribute selected from an attribute candidate pool, and a second item, selected from the item candidate pool and having a second attribute selected from the attribute candidate pool;
wherein the input response comprises a rejection of the first item;
wherein updating the state model to reflect the input response in reply the first item bundle comprises removing the first item from the item candidate pool, based on rejection of the first item; and
wherein the second item bundle excludes the first item.

3. The method of claim 1, further comprising:
receiving a second input response indicating rejection of the second item bundle, wherein the second item bundle comprises a first item and a second item, wherein the first item is selected from an item candidate pool of the state model and has a first attribute selected from an attribute candidate pool of the state model, and wherein the second item is selected from the item candidate pool and has a second attribute selected from the attribute candidate pool;
updating the state model to reflect the rejection of the second item bundle;
applying the ML conversation module to the state model to determine a second action type as a follow-up to the rejection of the second item bundle;
based on selection of a question action as the second action type, applying an ML question module to the state model to generate a question related to the first attribute of the first item;
receiving a third input response in response to the question; and
updating the state model based on the third input response.

4. The method of claim 3, further comprising jointly training the ML conversation module, the ML bundling module, and the ML question module using offline pre-training and online fine-tuning.

5. The method of claim 3, wherein updating the state model based on the third input response comprises:
updating the attribute candidate pool by removing the first attribute from the attribute candidate pool; and
updating the item candidate pool by removing from the item candidate pool one or more items having the first attribute.

6. The method of claim 5, further comprising applying the ML bundling module to the state model to generate a third item bundle based on the updated item candidate pool and the updated attribute candidate pool.

7. The method of claim 1, wherein the response to the first item bundle comprises a rejection of a first item in the first item bundle and an acceptance of a second item in the first item bundle; and
wherein updating the state model to reflect the response to the first item bundle comprises:
removing the first item from an item candidate pool of the state model, based on the rejection of the first item; and
adding the second item to a short-term context of the state model, the short-term context representing accepted items for a target bundle, based on the acceptance of the second item.

8. The method of claim 1, wherein the state model comprises (i) a long-term preference describing previously accepted item bundles, (ii) a short-term context describing accepted items and accepted attributes for a target item bundle, and (iii) one or more candidate pools describing items that are candidates for the target item bundle; and
wherein updating the state model to reflect the response to the first item bundle comprises updating the short-term context and the one or more candidate pools.

9. A system comprising:
a memory component storing a state model comprising an item candidate pool and an attribute candidate pool;
a machine-learning (ML) bundling module comprising program code for generating a first item bundle comprising a first item and a second item, the first item selected from the item candidate pool and having a first attribute selected from the attribute candidate pool, the second item selected from the item candidate pool and having a second attribute selected from the attribute candidate pool;
a modeling module comprising program code for updating the state model to reflect an input response to the first item bundle;
an ML conversation module comprising program code for:
determining, based on the state model, an action type as a follow-up to the response to the first item bundle; and
triggering an ML recommendation model based on the action type being a recommendation action; and
the ML bundling module further comprising program code for generating and outputting, based on selection of a recommendation action as the action type, a second item bundle different than the first item bundle.

10. The system of claim 9, wherein the modeling module further comprises program code for receiving a second input response indicating rejection of the second item bundle and updating the state model to reflect the rejection of the second item bundle, wherein the second item bundle comprises a first item and a second item, wherein the first item is selected from an item candidate pool of the state model and has a first attribute selected from an attribute candidate pool of the state model, and wherein the second item is selected from the item candidate pool and has a second attribute selected from the attribute candidate pool; and
wherein the ML conversation module further comprises program code for inputting the state model to determine a second action type as a follow-up to the rejection of the second item bundle and triggering an ML question module based on the second action type being a question action;
wherein the ML question module comprises program code for inputting the state model to generate a question related to the first attribute of the first item; and
wherein the modeling module further comprises program code for updating the state model to reflect a third input response received in response to the question.

11. The system of claim 10, wherein updating the state model based on the third input response comprises: updating the attribute candidate pool by removing the first attribute from the attribute candidate pool, and updating the item candidate pool by removing from the item candidate pool one or more items having the first attribute; and
wherein the ML bundling module further comprises program code for inputting the state model to generate a third item bundle based on the updated item candidate pool and the updated attribute candidate pool.

12. The system of claim 9, wherein the state model comprises a long-term preference describing previously accepted item bundles, a short-term context describing accepted items and accepted attributes for a target item bundle, and one or more candidate pools describing items that are candidates for the target item bundle; and
Wherein updating the state model to reflect the response to the first item bundle comprises updating the short-term context and the one or more candidate pools.

13. The system of claim 12, wherein:
the response to the first item bundle comprises a rejection of a first item in the first item bundle and an acceptance of a second item in the first item bundle; and
updating the state model to reflect the response to the first item bundle comprises:
removing the first item from an item candidate pool of the state model, based on the rejection of the first item; and
adding the second item to a short-term context of the state model, the short-term context representing accepted items for a target bundle, based on the acceptance of the second item.

14. A method comprising:
receiving a first input response in reply to a first item bundle comprising one or more items;
updating a state model to reflect the first input response in reply to the first item bundle;
applying a machine-learning (ML) conversation module to the state model to determine an action type as a follow-up to the input response to the first item bundle;
based on selection of a question action as the action type, applying an ML question module to the state model to generate a question related to the one or more items in the first item bundle;
outputting the question;
updating the state model to reflect a second input response received in reply to the question; and
applying the ML conversation module to the state model to determine a second action type as a follow-up to the second input response.

15. The method of claim 14, further comprising:
based on selection of a recommendation action as the second action type, applying an ML bundling module to the state model to generate a second item bundle different than the first item bundle; and
recommending the second item bundle.

16. The method of claim 15, further comprising jointly training the ML conversation module, the ML bundling module, and the ML question module.

17. The method of claim 16, wherein jointly training the ML conversation module, the ML bundling module, and the ML question module comprises offline pre-training and online fine-tuning.

18. The method of claim 14, wherein updating the state model to reflect the second input response received in reply to the question comprises updating an attribute candidate pool of the state model to remove one or more attributes, wherein a recommended item bundle is selected according to attributes in the attribute candidate pool.

19. The method of claim 14, wherein updating the state model to reflect the second input response received in reply to the question further comprises updating a category candidate pool of the state model to remove one or more categories, wherein a recommended item bundle is selected according to categories in the category candidate pool.

20. The method of claim 14, wherein updating the state model to reflect the first input response in reply to the first item bundle comprises:
removing one or more items from an item candidate pool of the state model, wherein a recommended item bundle comprises items selected from the item candidate pool; and
adding one or more items to a short-term context of the state model, wherein the short-term context indicates accepted items in a target item bundle.
